(19) United States
(12) Patent Application Publication
(10) Pub. No.: US 2021/0239881 A1
(43) Pub. Date: Aug. 5, 2021

(54) LENS ASSEMBLY CONSTRUCTS AND SMART DEVICE WITH LENS ASSEMBLY CONSTRUCTS

(71) Applicant: SEKONIX CO., LTD., Dongducheon-si (KR)

(72) Inventors: Soon Cheol Choi, Namyangju-si (KR); Ki Youn Noh, Dongducheon-si (KR); Seung Nam Nam, Namyangju-si (KR); Jae Won Moon, Dongducheon-si (KR)

(21) Appl. No.: 17/165,927

(22) Filed: Feb. 2, 2021

(30) Foreign Application Priority Data
Feb. 3, 2020 (KR) 10-2020-0012725

(51) Int. Cl. G02B 1/11; G02B 7/02

(52) U.S. Cl. CPC G02B 1/11; G02B 13/18; G02B 7/022; G02B 7/021

(57) ABSTRACT

The lens assembly construct used for a smart device according to the present invention comprises a plurality of lenses and a barrel enclosing the plurality of lenses, wherein the head of the barrel may be positioned below the center of the front surface of a first lens, which is outermost of the plurality of lenses, wherein the first lens may comprise an effective aperture portion and a flange portion, and a coating layer in which one or more dielectric layers are laminated may be formed on the effective aperture portion, and wherein a colored layer may be formed on at least a part of the surface of the first lens except the effective aperture portion on which the coating layer is formed. In addition, the smart device of the present invention may comprise a display having a hole in an active area and the lens assembly construct, and the lens assembly construct may be disposed under the hole. This achieves an effect of reduction in the external diameter compared with a lens module with a conventional HIAA structure, which leads to minimizing display loss.

### CROSS-REFERENCE TO RELATED APPLICATIONS

This application claims the benefit of and priority to Korean Application No. 10-2020-0012725, filed Feb. 3, 2020, the disclosure of which is incorporated herein in its entirety by reference.

### TECHNICAL FIELD

The present invention relates to a lens assembly construct comprising a plurality of lenses stacked along an optical axis and a barrel accommodating the same, and to a smart device having the lens assembly construct.

### BACKGROUND

With the recent increase in the demand for a maximized area of a display of smart devices, a so-called hole-in-active-area (HIAA) structure has been adopted in which a hole is made in an active area of a display and a camera lens is placed under it. In this case, in order to minimize display loss of the smart device due to the lens module, it is necessary to minimize the size of the hole corresponding to the front camera lens.

In a conventional HIAA structure of a smart device, a lens module is disposed under a hole of a display where, as shown in FIG. 2, a stop that limits the amount of light reaching the inside of the lens module from the outside is positioned on the upper surface of the lens to minimize its effective aperture portion and the outer diameter of a barrel head. That is, the barrel accommodating the lens module has a structure with an opening of the size of the effective aperture portion 211 on the front portion of the lens 210 positioned closest to the subject side, and it also has a protruding portion 213 protruding toward the effective aperture portion 211 and a barrel breadth portion 214. By reducing the breadth of the barrel breadth portion 214, the outer diameter of the barrel head is minimized so that the portion is inserted into the hole of the display. However, the lens module of such a structure causes display loss by as much as the protruding portion 213 and the barrel breadth portion 214 in order to secure the size of the needed effective aperture portion 211, and it is necessary to minimize the loss.

### DETAILED DESCRIPTION OF THE INVENTION

### Problem to be Solved

The object of the present invention is to minimize the loss of the display area due to a lens of a camera in a HIAA-structured smart device in which a hole is made in an active area of the display and a camera lens is installed under it.

The problem to be solved by the present invention is not limited thereto, and may be variously extended without departing from the spirit and scope of the present invention.

### Means for Solving the Problem

In order to solve the problem, a lens assembly construct used for a smart device according to an embodiment of the present invention comprises a plurality of lenses stacked along an optical axis and a barrel accommodating the plurality of lenses, wherein the plurality of lenses comprise a first lens positioned closest to a subject side, and the head of the barrel is positioned below the center of the front surface of the first lens, wherein the first lens comprises an effective aperture portion and a flange portion, and a coating layer in which one or more dielectric layers are laminated is formed on the effective aperture portion, and wherein a colored area is formed in the surface of the first lens, on at least a part of the flange portion of the first lens except the effective aperture portion on which the coating layer of the first lens is formed, by heating the first lens higher than a first temperature, making a dye permeate through the pores of the surface, and then lowering the temperature below the first temperature to make the dye permeate into the surface of the first lens for coloring.

In an example, the plurality of lenses may comprise a second lens positioned below and adjacent to the first lens, and a stop of the lens assembly construct may be positioned above the front surface of the second lens.

In an example, the head of the barrel may be at least 0.3 mm below the center of the front surface of the first lens.

In an example, the entire flange portion except the effective aperture portion on which the coating layer of the first lens is formed may be permeated with the dye for coloring.

In an example, the coating layer may be an anti-reflective coating layer.

In an example, the linear coefficient of thermal expansion of the dielectric layer may be lower than the linear coefficient of thermal expansion of the first lens. In addition, the linear coefficient of thermal expansion of the first lens may be 5×10⁻⁵/° C. or higher, and the linear coefficient of thermal expansion of the dielectric layer may be 1×10⁻⁵/° C. or lower.

In an example, the transmittance of light in the wavelength range of the visible light region of the portion of the first lens on which the colored area is formed may be 40% or lower, and the transmittance of light in the wavelength range of the visible light region of the portion of the first lens on which the colored area is not formed may be 90% or higher.

In an example, the front surface of the first lens may have a convex shape protruding toward the subject side, and the first lens may be made of plastic.

In an example, the plurality of lenses may include three or more single lenses.

In an example, the color of the dye may be black.

A lens assembly construct used for a smart device according to another embodiment of the present invention comprises a plurality of lenses stacked along an optical axis and a barrel accommodating the plurality of lenses, wherein the plurality of lenses comprise a first lens positioned closest to a subject side, and the head of the barrel is positioned below the center of the front surface of the first lens, wherein the first lens comprises an effective aperture portion and a flange portion, and the flange portion comprises an inclined portion, and wherein a colored layer is formed by printing on at least a part of the front surface of the inclined portion by spraying a paint.

In an example, a stop of the lens assembly construct may be positioned above the rear surface of the first lens.

In an example, the head of the barrel may be at least 0.3 mm below the center of the front surface of the first lens.

In an example, the colored layer may be formed by printing on at least a part of the front surface and at least a part of the rear surface of the inclined portion with a paint.

In an example, the colored layer may be formed by printing on an end portion of the effective aperture portion of the first lens with a paint.

In an example, the front surface of the first lens may have a convex shape protruding toward the subject side, and the first lens may be made of plastic.

In an example, the plurality of lenses may include three or more single lenses.

In an example, the color of the paint may be black.

A smart device according to an embodiment of the present invention comprises a display having a hole in an active area and a lens assembly construct, wherein the lens assembly construct is disposed under the hole.

### Effect of the Invention

According to the present invention, by forming a colored area in the area of a front portion exposed out of the barrel except for an effective aperture portion in a first lens of the lens assembly construct positioned closest to a subject side, a structure is achieved that allows blocking entry of unnecessary light thanks to the colored area to a certain area of the front portion of the first lens without a barrel. That is, the lens assembly construct according to the present invention can exhibit an effect of reduction in the external diameter, which corresponds to the breadth of the barrel, compared with a conventional lens module with the HIAA structure, thereby achieving minimizing a display loss.

### BRIEF DESCRIPTION OF THE DRAWINGS

FIG. 1 is a cross-sectional view showing a schematic structure of a lens assembly construct according to an example.

FIG. 2 is a cross-sectional view showing a schematic structure of a lens module according to conventional art.

FIG. 3 is a schematic view showing a schematic structure of a first lens positioned closest to the subject side among a plurality of lenses constituting a lens assembly construct according to an example.

FIGS. 4A and 4B are schematic views illustrating the principle of color permeation according to an example.

FIG. 5 is a perspective view illustrating a color-permeated area of a lens according to an example.

FIG. 6 is a cross-sectional view illustrating a lens in which a colored area is formed by color permeation according to an example.

FIG. 7 is a schematic view illustrating a method of color printing according to an example.

FIG. 8 is a cross-sectional view illustrating a lens in which a colored layer is formed by color printing according to an example.

### DETAILED DESCRIPTION TO CARRY OUT THE INVENTION

Hereinafter, examples of the present invention are described in detail with reference to the attached drawings so that a person having ordinary skill in the technical field to which the present invention pertains can easily carry out the invention. The attached drawings and the following descriptions relate to preferred forms among various forms for the purpose of illustrating the characteristics of the present invention. The present invention can be implemented in various different forms and is not limited to the examples described herein.

In the present invention, a smart device may be, for example, a smartphone or a tablet PC, but is not limited thereto, and may include a portable device that includes a display and can function as a camera.

A lens assembly construct according to the present invention may be disposed under a hole made in a display active area of a smart device, but is not limited thereto and can be applied in any form that can be used in a smart device. Among the plurality of lenses constituting the lens assembly construct of the present invention, the lens positioned closest to a subject side may have a colored portion formed in at least a part of an area of a front portion exposed out of the barrel except for an effective aperture portion. The colored portion may be formed as a colored area by color permeation with a dye to be described below, or may be formed as a colored layer by color printing with a paint to be described below.

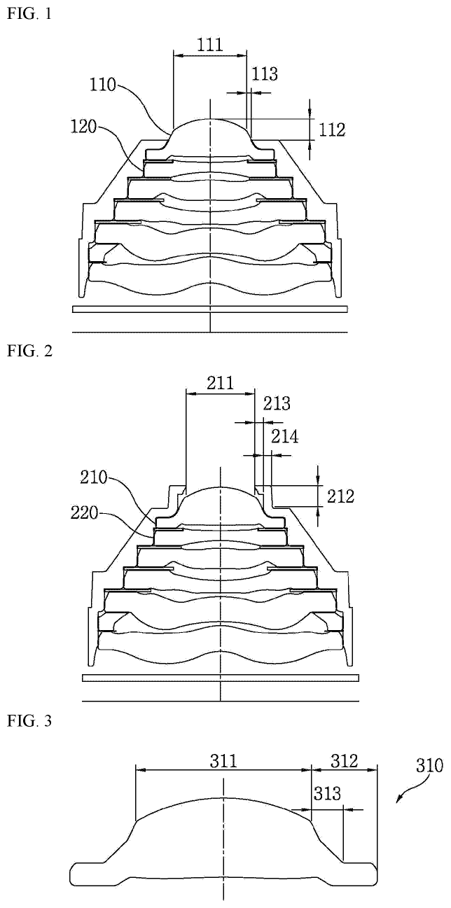

Referring to FIG. 1, a lens assembly construct according to an example of the present invention may comprise a plurality of lenses stacked along an optical axis. The plurality of lenses may comprise a first lens 110, a second lens 120, a third lens 130, a fourth lens 140, and the like, in order from the subject side. FIG. 1 illustrates that the lens assembly construct comprises six lenses, but the present invention is not limited thereto, and the number is not particularly limited as long as there are a plurality of lenses. As an example, the plurality of lenses may comprise three or more single lenses. The front surface of the first lens 110 may have a convex shape protruding toward the subject side.

Each of the plurality of lenses may comprise plastic. More specifically, the lens may consist of one of PC (polycarbonate), COC (cyclo olefin copolymer) and COP (cyclo olefin polymer) or comprise at least one of them. The types of the plastic material constituting the lenses are not limited thereto, and different known plastic materials may be used.

Meanwhile, a lens assembly construct according to an example of the present invention may comprise a barrel having an inner space for accommodating the plurality of lenses, with open upper and lower portions. The head of the barrel may be a front portion of an outer circumference of the barrel that faces the subject side and may be positioned below the center of the front surface of the first lens 110. For example, the head of the barrel may be at least 0.3 mm below the center of the front surface of the first lens. In an example, a stop of the lens assembly construct may be positioned above the front surface of the second lens 120. In another example, a stop of the lens assembly construct may be positioned above the rear surface of the first lens.

FIG. 3 shows a schematic structure of a first lens 310 positioned closest to the subject side among a plurality of lenses constituting a lens assembly construct according to an example. The first lens 310 may comprise an effective aperture portion 311 through which light passes for imaging a subject and a flange portion 312 fixed to the barrel. The flange portion 312, which is a portion constituting the periphery of the effective aperture portion for the purpose of fixing the lens to the barrel, may comprise an inclined portion 313 and a portion that is flat in a direction perpendicular to the optical axis. The first lens 310, which has a colored area formed in at least a part of the area except the effective aperture portion 311, which allows light to enter for imaging a subject, can block entry of unnecessary light. In addition, at least a part of the portion in which the colored area of the front portion of the first lens 310 is formed has a structure that is not blocked by the barrel. When the lens assembly construct of this structure is disposed in a hole in an active area of a smart device display, it is possible to minimize loss of the display.

In contrast, in the conventional lens module shown in FIG. 2, the protruding portion 213 in which the barrel protrudes toward the effective aperture portion 211 and the barrel breadth portion 214 blocked by the breadth of the barrel are positioned in the front portion of the first lens 210 positioned closest to the subject side, thereby blocking entry of light to an area except the effective aperture portion 211. That is, in the lens module having such structure, display loss equal to the protruding portion 213 and the barrel breadth portion 214 combined is inevitable in order to secure the size of the effective aperture portion 211 required. For example, assuming that the diameters of the effective aperture portion 211, the protruding portion 213, and the barrel breadth portion 214 are about 1.2 mm, about 0.2 mm, and the about 0.2 mm respectively in FIG. 2, the outer diameter of the barrel head is about 2.0 mm, which requires making a hole with a diameter of 2.0 mm or greater in the display.

By comparison, in the lens assembly construct of the present invention, assuming that the diameter of the effective aperture portion 111 is about 1.2 mm, and that the diameter of the exposed portion 113 in the front surface of the inclined portion of the first lens that is exposed out of the barrel is about 0.1 mm, the outer diameter of the barrel head is about 1.4 mm, which requires making a hole with a diameter of about 1.4 mm or greater in the display. This achieves an effect of reduction in the external diameter by about 0.6 mm compared with a convention lens module with the HIAA structure, thereby achieving minimizing display loss.

A colored portion is formed in at least a part of the area except the effective aperture portion of the first lens. In an embodiment of forming a colored portion, it is possible to form a colored portion by permeating a dye into at least a part of the flange portion of the lens for coloring. In another embodiment of forming a colored portion, it is possible to form a colored layer by printing in color at least a part of the front surface of the lens with a paint.

First, in one embodiment, a method of forming a colored area by having at least a part of the flange portion of the lens permeated with a dye for coloring is described. A coating layer in which one or more dielectric layers are laminated may be formed on the effective aperture portion of the lens. Then, the lens may be heated higher than a first temperature, a dye may be made to permeate through the pores of the surface, and then the temperature may be lowered below the first temperature to make the dye permeate into the interior of the surface of the lens for coloring on at least a part of the flange portion of the lens except the effective aperture portion on which the coating layer is formed. Or, in another embodiment, the lens may be permeated with a dye at the same time as the heating of the lens. Here, the first temperature may be room temperature, which may be a temperature between 20° C. and 30° C. Or, the first temperature may be a temperature between 0° C. and 60° C. However, the range of the first temperature is not limited to the above-mentioned examples and may include other temperature ranges. Then, the lens may be dried and cleaned. By the processes, the coating layer acts as a mask on the dye, and thus, the dye permeates only the portion of the lens on which the coating layer is not formed, which allows easy formation of the colored layer in the surface of the lens except the effective aperture portion.

It is also possible to have the entire flange portion except the effective aperture portion on which the coating layer is formed permeated with a dye for coloring. Through this, light that enters via an unintended optical path can be effectively absorbed to prevent occurrence of internal reflection more effectively.

A coating layer formed by laminating at least one dielectric layer on the effective aperture portion of the lens may be an anti-reflective coating layer. When the anti-reflective coating layer is formed on the effective aperture portion, it restricts the reflection of light that enters or comes out the effective aperture portion. This restricts introduction of light via unwanted paths, to more effectively prevent occurrence of internal reflection.

The coating layer formed on the effective aperture portion of the lens may be formed by laminating at least one dielectric layer by vacuum deposition where deposition material is vaporized or sublimated in vacuum by a heating device to be deposited on an object. The dielectric layer may comprise, for example, at least one of SiO₂, Al₂O₂ and TiO₂, but is not limited thereto, and it may comprise other known components of a dielectric layer.

After the processes of forming the coating layer on the effective aperture portion of the lens and color-permeating the dye, a dielectric layer may be additionally laminated on the surface of the lens. Accordingly, an additional process to improve the performance of the lens can be carried out even after the formation of the colored area.

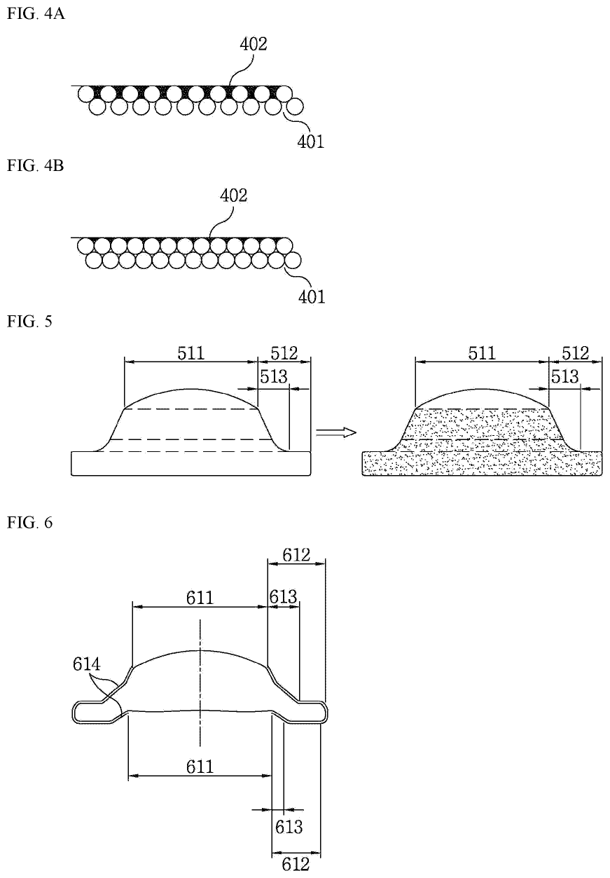

With reference to FIGS. 4A and 4B, a description is given of the principle of permeating a dye into the flange portion of the lens for coloring. FIG. 4A is a molecular level schematic view of a dye 402 as applied when material 401 constituting the lens is heated up. More specifically, when the material 401 is heated, the space between the molecules widens to open the pores. When the dye 402 is applied at this point, the dye 402 permeates through the pores of the material 401. FIG. 4B is a molecular level schematic view of the material 401 where the temperature has dropped after the dye 402 was applied to it in a state where it was heated. If the temperature is lowered in the state where the material 401 is permeated with the dye 402, it causes the space between the molecules of the material 401 to shrink, but then, the dye 402 has already permeated through the pores. That is, the temperature is lowered while the dye 402 has permeated and colored the inside of the material 401, as shown in FIG. 4B.

However, if the material 401 has a low linear coefficient of thermal expansion, the dye 402 may not permeate the material, because the pores do not open sufficiently. For this reason, even when the dye 402 is applied after materials having different linear coefficients of thermal expansion have been heated at the same temperature, the dye 402 may permeate and color only the surface of the material having a high linear coefficient of thermal expansion, thereby forming a colored layer inside the surface, but the dye 402 may not permeate the surface of the material having a low linear coefficient of thermal expansion, failing to form a colored layer.

Accordingly, the linear coefficient of thermal expansion of the dielectric layer may preferably be lower than the linear coefficient of thermal expansion of the lens. In particular, the linear coefficient of thermal expansion of the dielectric layer may be lower than the linear coefficient of thermal expansion of the portion of the lens on which a colored area is formed. Accordingly, even when the dye is applied after the coating layer consisting of at least one dielectric layer is heated together with the lens, only the portion of the lens on which a colored area is to be formed is colored with the dye, without coloring the coating layer, to prevent interference with the light passing through the effective aperture portion. More preferably, the linear coefficient of thermal expansion of the lens may be 5×10⁻⁵/° C. or higher to 5×10⁻⁴/° C. or lower, and the linear coefficient of thermal expansion of the dielectric layer may be 1×10⁻⁷° C. or higher to 1×10⁻⁵/° C. or lower.

A colored area may also be formed by immersing the lens in a dye. In this case, it makes it easy for the dye to permeate the entire flange portion except for the effective aperture portion, where the coating layer acts as a mask to prevent the permeation of the dye. In an example, immersing the lens in a dye may be performed for the period of 10 minutes or more to 60 minutes or less. By immersing the lens in the dye for the period of 10 minutes or more, it is possible to easily form the colored area inside and, by immersing the lens in the dye for the period of 60 minutes or less, it is possible to prevent the dye from being laminated to form an unnecessary layer on the surface of the lens.

The temperature of the dye may be 60° C. or higher to 90° C. or lower. When the temperature of the dye is in that range, it is possible to heat the lens to a temperature higher than the first temperature, which is room temperature for example, without a separate device or process.

The dye used for color permeation may have a color that absorbs light in the wavelength range of the visible light region. For example, it may be blue, red, yellow, orange, or violet. Here, the wavelength range of the visible light region may be a range of 400 nm or higher to 700 nm or lower. In an example, the color of the dye 202 may be black. In addition, the dye may be a disperse dye and may be obtained by mixing dyes of various colors. For example, a disperse dye may be obtained by mixing the following five categories of dyes.

(1) Blue dyes:

Dianix Blue AC-E, Dianix Blue RNE (C.I. Disperse Blue 91), Dianix Blue GRE (C.I. Disperse Blue 81), Sumikaron Blue E-R (C.I. Disperse Blue 91), and Kayaron Polyester Blue GR-E (C.I. Disperse Blue 81)

(2) Red dyes:

Dianix Red AC-E, Diaceliton Fast Red R (C.I. Disperse Red 17), Diaceliton Fast Scarlet R (C.I. Disperse Red 7), Diaceliton Fast Pink R (C.I. Disperse Red 4), Sumikaron Rubin SE-RPD, and Kayaron Polyester Rubin GL-SE200 (C.I. Disperse Red 73)

(3) Yellow dyes:

Dianix Yellow AC-E, Dianix Yellow YL-SE (C.I. Disperse Yellow 42), Sumikaron Yellow SE-RPD, Diaceliton Fast Yellow GL (C.I. Disperse Yellow 33), Kayaron Fast Yellow GL (C.I. DisPerth Yellow 33), and Kayaron Microester Yellow AQ-LE

(4) Orange dyes:

Dianix Orange B-SE200 (C.I. Disperse Orange 13), Diaceliton Fast Orange GL (C.I. Disperse Orange 3), Miketon Polyester Orange B (C.I. Disperse Orange 13), Sumikaron Orange SE-RPD, and Sumikaron Orange SE-B (C.I. Disperse Orange 13)

(5) Violet dyes:

Dianix Violet 5R-SE (C.I. Disperse Violet 56) and Sumikaron Violet E-2RL (C.I.

Disperse Violet 28).

The transmittance of light in the wavelength range of the visible light region of the portion of the lens on which the colored area is formed may be 40% or lower, and the transmittance of light in the wavelength range of the visible light region of the portion of the lens on which the colored area is not formed may be 90% or higher. Here, the method for measuring the transmittance of light in the wavelength range of the visible light region may be by measuring the ratio of the intensity of the incident light after the light in the wavelength range of the visible light region has been projected to the intensity of the projected light over the entire wavelength range of the visible light region. If the transmittance of the light in the entire wavelength range of the visible light region is at a particular level or higher, it can be said that the transmittance of the light in the wavelength range of the visible light region is equal to or higher than the particular level. If the transmittance of the light in the entire wavelength range of the visible light region is at a particular level or lower, it can be said that the transmittance of the light in the wavelength range of the visible light region is equal to or lower than the particular level.

FIG. 5 is a perspective view comparing the lens as seen from the side before and after the colored area is formed by having the flange portion 512 of the lens permeated with a dye for coloring. The lens on the left is in a state before the color permeation with a dye, and the lens on the right is in a state where the entire flange portion 512 including the inclined portion 513 is color permeated with a dye. In the lens on the left where it is not color-permeated with the dye, the image quality may be degraded due to entry of unnecessary light and internal reflection as light passes through the area other than the effective aperture portion 511. In the lens on the right where the flange portion 512 is color-permeated with the dye, the passage of light is prevented, making it possible to restrict entry of unnecessary light and internal reflection. FIG. 6 is a cross-sectional view illustrating an example of a color-permeated area of the lens. Since the colored area 614 is formed in the entire flange portion 612 of the lens including the inclined portion 613, it is possible to restrict entry of unnecessary light to the area except the effective aperture portion 611 and internal reflection.

When a colored area is formed on the lens by permeating a dye, only one processing is required even when both surfaces of the lens are processed, which is advantageous in terms of both cost and time. In addition, because a colored layer can be formed regardless of the shape of the lens, the colored area can be formed easily even when the lens comprises a gate cutting portion or has an unusual shape with a side surface portion, such as the shape of a D-cut lens. Further, because a dye permeates into the lens for coloring, it does not affect the thickness of the lens; thus, it does not interfere with precise assembling of a lens assembly construct even when the colored layer is formed.

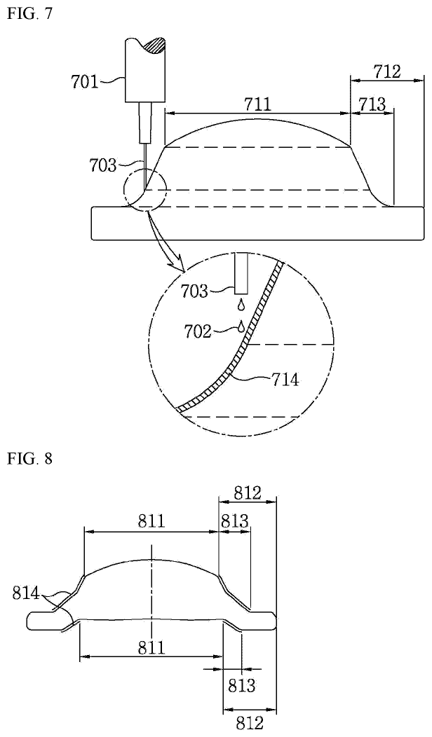

According to another embodiment, with reference to FIG. 7, a description is given of a method of forming a colored layer 714 by printing a paint on at least a part of the front surface of the lens. A printing device 701 may comprise a probe 703. The probe 703 may spray a paint 702 toward at least a part of the front surface of the inclined portion 713 included in the flange portion 712 of the lens. For example, the color of the paint may be black. Accordingly, a colored layer 714 having a desired thickness is formed on the inclined portion 713 to prevent light from passing through optically unused portions of the lens except the effective aperture portion 711, thereby preventing the image quality from being degraded due to entry of unnecessary light and internal reflection. FIG. 7 illustrates spraying a paint 702 by a printing device 701 comprising a probe 703 as an example of a method of printing a paint on at least a part of the front surface of the lens, but the present invention is not limited thereto, and the invention may have any structure that allows printing a paint on a desired part of the lens.

FIG. 8 is a cross-sectional view of a lens on which a colored layer 814 is formed by printing a paint. As shown in FIG. 8, a colored layer 814 may be formed on each side of the inclined portion 813 by printing a paint on at least a part of the front surface and at least a part of the rear surface of the inclined portion 813 of the flange portion 812 of the lens. In this case, it is possible to prevent the image quality from being degraded due to entry of unnecessary light to the area outside the effective aperture portion 811 and internal reflection. In an example, a colored layer may be formed by printing a paint on an end portion of the effective aperture portion of the lens.

The terms used in the present application are only used to describe specific embodiments, and are not intended to limit the present invention. Singular expressions include plural expressions unless the context clearly indicates otherwise. In the present application, terms such as ‘comprise’ or ‘have’ are intended to mean that the stated characteristics, numbers, steps, operations, constituents, parts or a combination thereof are present, and should not be understood to preclude the possibility of addition or presence of one or more of other characteristics, numbers, steps, operations, constituents, parts or a combination thereof.

Unless otherwise defined, all terms used herein, including technical or scientific terms, have the same meaning as those commonly understood by a person having ordinary skill in the art to which the present invention belongs. A term defined in a commonly used dictionary should be interpreted as having a meaning consistent with a meaning in the context of the related technology, and should not be interpreted to have an ideal or excessively formal meaning unless explicitly defined in this application.

### REFERENCE NUMERALS

110, 210, 310: first lens
120, 220: second lens
111, 211, 311, 511, 611, 711, 811: effective aperture portion
112, 212: inserted portion
113: exposed portion
213: protruding portion
214: barrel breadth portion
312, 512, 612, 712, 812: flange portion
313, 513, 613, 713, 813: inclined portion
401: material
402: dye
614: colored area
701: printing device
702: paint
703: probe
714, 814: colored layer

What is claimed is:

1. A lens assembly construct used for a smart device comprising a plurality of lenses stacked along an optical axis and a barrel accommodating the plurality of lenses,
wherein the plurality of lenses comprise a first lens positioned closest to a subject side, and the head of the barrel is positioned below the center of the front surface of the first lens,
wherein the first lens comprises an effective aperture portion and a flange portion, and a coating layer in which one or more dielectric layers are laminated is formed on the effective aperture portion, and
wherein a colored area is formed in the surface of the first lens, on at least a part of the flange portion of the first lens except the effective aperture portion on which the coating layer of the first lens is formed, by heating the first lens higher than a first temperature, making a dye permeate through the pores of the surface, and then lowering the temperature below the first temperature to make the dye permeate into the surface of the first lens for coloring.

2. The lens assembly construct used for a smart device according to claim 1,
wherein the plurality of lenses comprise a second lens positioned below and adjacent to the first lens, and
wherein a stop of the lens assembly construct is positioned above the front surface of the second lens.

3. The lens assembly construct used for a smart device according to claim 1,
wherein the head of the barrel is at least 0.3 mm below the center of the front surface of the first lens.

4. The lens assembly construct used for a smart device according to claim 1,
wherein the entire flange portion except the effective aperture portion on which the coating layer of the first lens is formed is permeated with the dye for coloring.

5. The lens assembly construct used for a smart device according to claim 1,
wherein the coating layer is an anti-reflective coating layer.

6. The lens assembly construct used for a smart device according to claim 1,
wherein the linear coefficient of thermal expansion of the dielectric layer is lower than the linear coefficient of thermal expansion of the first lens.

7. The lens assembly construct used for a smart device according to claim 6,
wherein the linear coefficient of thermal expansion of the first lens is 5×10⁻⁵PC or higher, and the linear coefficient of thermal expansion of the dielectric layer is 1×10⁻⁵PC or lower.

8. The lens assembly construct used for a smart device according to claim 1,
wherein the transmittance of light in the wavelength range of the visible light region of the portion of the first lens on which the colored area is formed is 40% or lower, and
wherein the transmittance of light in the wavelength range of the visible light region of the portion of the first lens on which the colored area is not formed is 90% or higher.

9. The lens assembly construct used for a smart device according to claim 1,
wherein the front surface of the first lens has a convex shape protruding toward the subject side, and the first lens is made of plastic.

10. The lens assembly construct used for a smart device according to claim 1,
wherein the plurality of lenses includes three or more single lenses.

11. The lens assembly construct used for a smart device according to claim 1,
wherein the color of the dye is black.

12. A smart device comprising a display having a hole in an active area and a lens assembly construct according to claim 1,
wherein the lens assembly construct is disposed under the hole.

13. A lens assembly construct used for a smart device comprising a plurality of lenses stacked along an optical axis and a barrel accommodating the plurality of lenses,
wherein the plurality of lenses comprise a first lens positioned closest to a subject side, and the head of the barrel is positioned below the center of the front surface of the first lens,
wherein the first lens comprises an effective aperture portion and a flange portion, and the flange portion comprises an inclined portion, and
wherein a colored layer is formed by printing on at least a part of the front surface of the inclined portion by spraying a paint.

14. The lens assembly construct used for a smart device according to claim 13,
wherein a stop of the lens assembly construct is positioned above the rear surface of the first lens.

15. The lens assembly construct used for a smart device according to claim 13,
wherein the head of the barrel is at least 0.3 mm below the center of the front surface of the first lens.

16. The lens assembly construct used for a smart device according to claim 13,
wherein the colored layer is formed by printing on at least a part of the front surface and at least a part of the rear surface of the inclined portion with a paint.

17. The lens assembly construct used for a smart device according to claim 13,
wherein the colored layer is formed by printing on an end portion of the effective aperture portion of the first lens with a paint.

18. The lens assembly construct used for a smart device according to claim 13,
wherein the front surface of the first lens has a convex shape protruding toward the subject side, and the first lens is made of plastic.

19. The lens assembly construct used for a smart device according to claim 13,
wherein the plurality of lenses includes three or more single lenses.

20. The lens assembly construct used for a smart device according to claim 13,
wherein the color of the paint is black.
